(19) United States
(12) Patent Application Publication
(10) Pub. No.: US 2004/0247252 A1
(43) Pub. Date: Dec. 9, 2004

(54) Retractable fiber optic connector housing

(76) Inventors: John Ehrenreich, Ellicott City, MD (US); Michael Dahan, Owings Mills, MD (US)

Correspondence Address: HOWREY SIMON ARNOLD & WHITE LLP, ATTORNEYS AT LAW, 750 BERING DRIVE, HOUSTON, TX, 77057-2198, US

(21) Appl. No.: 10/789,473

(22) Filed: Feb. 27, 2004

Related U.S. Application Data
(60) Provisional application No. 60/450,610, filed on Feb. 28, 2003.

(51) Int. Cl. G02B 6/38

(52) U.S. Cl. 385/58

(57) ABSTRACT

A fiber optic connector used for data communication and telecommunication applications is disclosed. A latch pull is used to decouple the fiber optic connector from a receptacle. The latch pull provides easier removal of the fiber optic connector than prior art connector removal mechanisms, thereby enabling high-density fiber optic installations.

### PRIORITY CLAIM

This application claims the benefit of U.S. Provisional Patent Application Ser. No. 60/450,610 filed on Feb. 28, 2003, which is hereby incorporated by reference in its entirety.

### BACKGROUND OF THE INVENTION

The present disclosure relates to a fiber optic connector used for data communication and telecommunication applications, and particularly to a fiber optic connector that is easier to install and remove from a receptacle in high-density installations.

Optical fibers are an integral part of modern signal transmission systems. Optical fiber connectors are used to connect optical fibers to various receptacles, such as connecting segments of fibers together to make longer lengths, connecting fibers to active devices such as radiation sources, detectors, and amplifiers, and connecting fibers to passive devices such as switches, dividers, and attenuators. The connection between a pair of optical fiber ends typically consists of a pair of ferrules, small capillary cylinders made of glass, ceramic, or plastic fiber, which are butted together end-to-end in a manner that allows light to travel from one to the other along their common central axis. As such, optical fiber connectors perform three basic functions:

1. Provide accurate positioning and abutment of the two ferrules;

2. Provide maximum transfer of optical signals with minimal signal loss; and

3. Provide a stable mechanical joint with the receptacle so that no unintended decoupling occurs.

Optical fiber connectors are known in the art. One type of conventional connector is described in detail in U.S. Pat. No. 5,481,634 to Anderson et al., which is herein incorporated by reference. The connector disclosed in that patent comprises a cylindrical ceramic ferrule, which protrudes through an opening in a plastic housing body. A cylindrical spring surrounds the ferrule and interacts with an interior surface of the housing body to urge the ferrule axially outward from the housing opening. The housing body has a cantilever-type spring latch located on one exterior side of the connector which is manually operable and which mates with a shoulder within the receptacle to lock the connector therein. When a connection is made, the ferrule first seats on the optical interface of the mating ferrule or active device. The housing body then continues to advance until the cantilever latch clears the latching shoulder on the receptacle. The internal spring absorbs this additional axial advance, and continues to apply axial force between the latch and the receptacle to maintain intimate contact at the optical interface.

The connector of the referenced patent is but one type of fiber optic connector. ST, SC, VF 45, and MTRJ connectors are also commonly used in fiber optic systems. With the increasing use of optical fibers as transmission media, the general design concept behind the development of the connector described above was to create a simple device that could achieve higher density installations, i.e. more tightly spaced fiber optic connections. One feature of such connectors that prevents maximum packing density is the latching mechanism. Although advertised as easily removable by using only the tip of the finger on the latching mechanism, this in reality is only true when the connector is relatively unobstructed. To achieve the maximum packing configurations for which the connector was designed to achieve, it is far more difficult and perhaps impossible for an operator to remove a connector in a high density installation without grasping the connector body and latch, or by using some other tool to depress the latch. It is still highly desirable to provide a fiber optic connector that facilitates the easy installation and the easy removal of the connector in a variety of installation configurations, including high-density installations.

### SUMMARY OF THE DISCLOSED SUBJECT MATTER

The subject matter of this disclosure overcomes the above-discussed shortcomings and satisfies a significant need for a fiber optic connector that can be more easily removed from fiber optic receptacles in high-density installations. One fiber optic connector constructed in accordance with certain teachings herein has a connector body, a latch attached to the connector body and capable of coupling with a fiber optic receptacle, and a movable latch pull having a cavity capable of at least partially enclosing the latch and at least one inclined plane that is slidable against the latch. The latch pull is engaged to the connector body in a manner so as to allow the latch pull to slide over the connector body. By moving the latch pull away from the fiber optic receptacle, at least one inclined plane of the latch pull slides against the latch, thus forcing the latch into a position closer to the connector body, thereby decoupling the latch from the fiber optic receptacle. Another illustrative embodiment provides a strain relief boot affixed to the latch pull, whereby moving the strain relief boot away from the fiber optic receptacle forces the latch into a position closer to the connector body, thus decoupling the connector body from the fiber optic receptacle.

Alternate latching mechanisms are also provided. One embodiment utilizes a latch that is biased into a position close to the connector body. Another embodiment utilizes a latch that is connected to the connector body by means of a hinging mechanism. In both of these embodiments, by moving the latch pull towards the fiber optic receptacle, at least one inclined plane of the latch pull slides against the latch, thus forcing the latch into a position away from the connector body, and into a coupling position with the fiber optic receptacle. The inclined planes are also oriented so as to allow the latch to return to a position closer to the connector body when the latch pull is moved away from the fiber optic receptacle, thus decoupling the latch from the fiber optic receptacle.

### BRIEF DESCRIPTION OF THE DRAWINGS

A more complete understanding of the disclosed subject matter may be obtained with reference to the accompanying drawings:

FIG. 1 is a perspective view of one embodiment of a fiber optic connector in accordance with certain teachings of the present disclosure, cantilever beam latch biased down, shown in a fully latched configuration, with an alternate embodiment duplex design shown in phantom.

FIG. 2 is a cross-sectional perspective view of another embodiment of a fiber optic connector in accordance with certain teachings of the present disclosure, cantilever beam latch biased down, shown in a fully latched configuration.

FIG. 3 is an exploded perspective view of one embodiment of a fiber optic connector in accordance with certain teachings of the present disclosure, cantilever beam latch biased down.

FIG. 4 is a cross-sectional side view of a preferred embodiment fiber optic connector in accordance with certain teachings of the present disclosure, cantilever beam latch biased up, shown fully latched with a receptacle.

FIG. 5 is a cross-sectional side view of a preferred embodiment fiber optic connector in accordance with certain teachings of the present disclosure, cantilever beam latch biased up, shown partially retracted from a receptacle.

FIG. 6 is a perspective view of one embodiment of the latch pull mechanism in accordance with certain teachings of the present disclosure, cantilever beam latch biased up, shown in a fully latched position.

FIG. 7A is a perspective view of another embodiment of the latch pull mechanism in accordance with certain teachings of the present disclosure, cantilever beam latch biased up, shown in a retracted configuration.

FIG. 7B is a perspective view of the latch pull mechanism of FIG. 7A, shown in a fully latched configuration.

FIG. 8 is an exploded perspective view of an alternate embodiment of the latch pull mechanism in accordance with certain teachings of the present disclosure, hinged latch.

FIG. 9 is a perspective view of another alternate embodiment of the latch pull mechanism in accordance with certain teachings of the present disclosure, cantilever beam latch biased down and located on the latch pull mechanism.

### DESCRIPTION OF ILLUSTRATIVE EMBODIMENTS

The present disclosure will now be described more filly with reference to the accompanying drawings in which a preferred embodiment of the invention is shown. This disclosure may, however, be embodied in many different forms and should not be construed as being limited to the embodiment set forth herein.

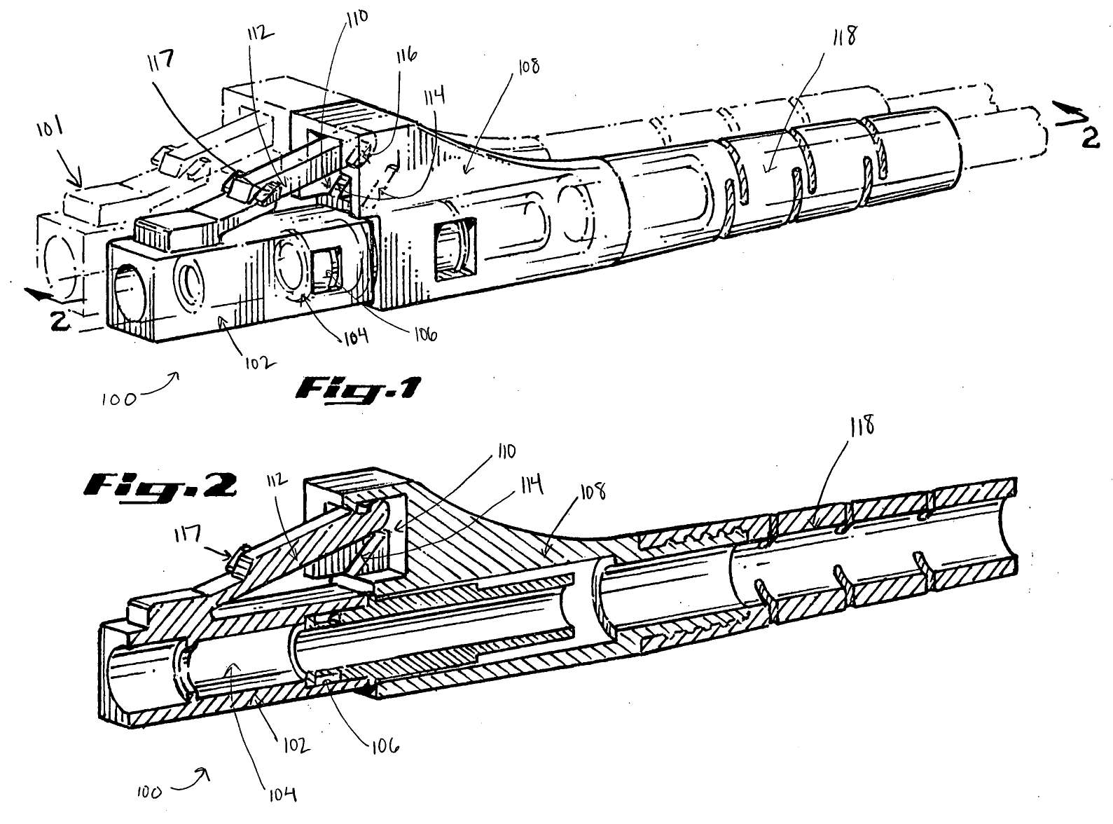

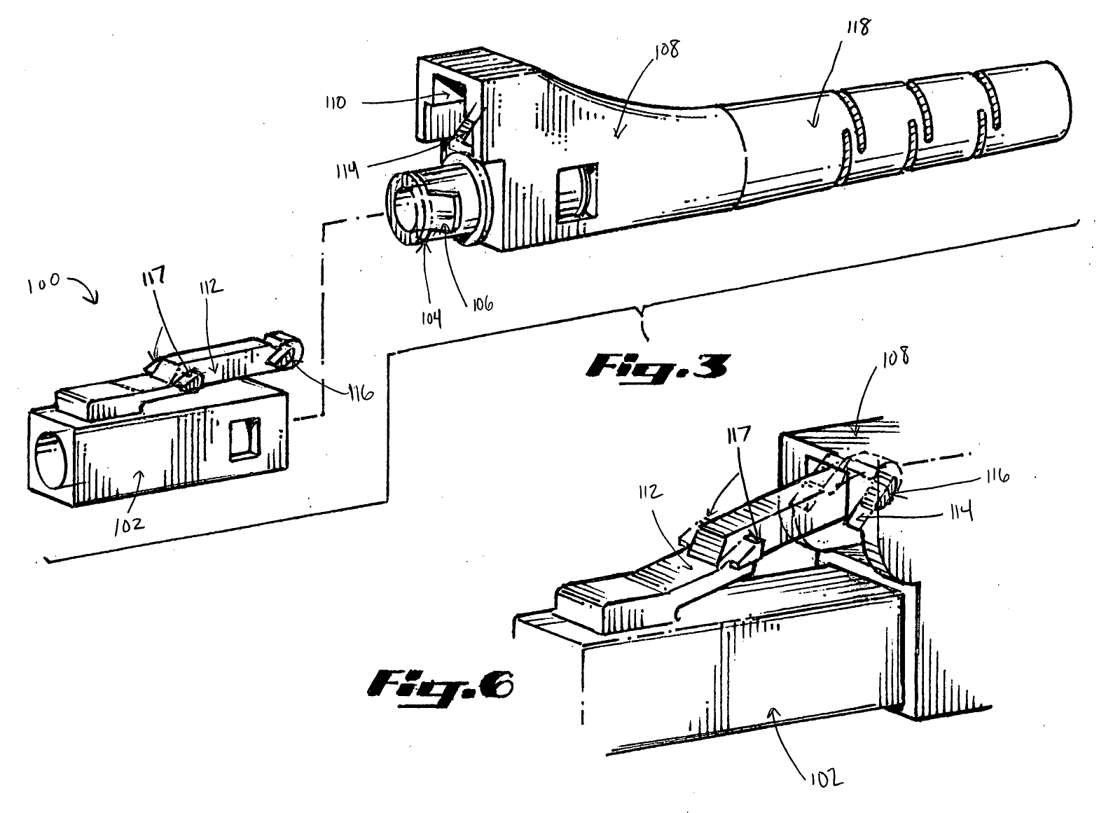

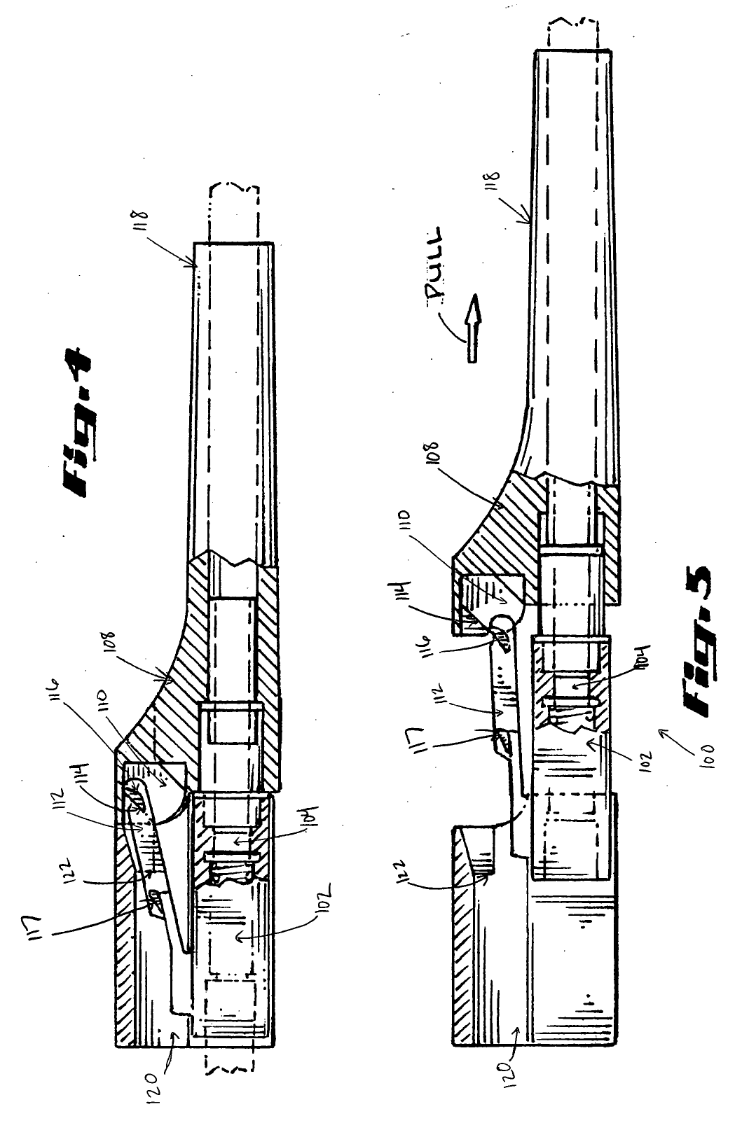

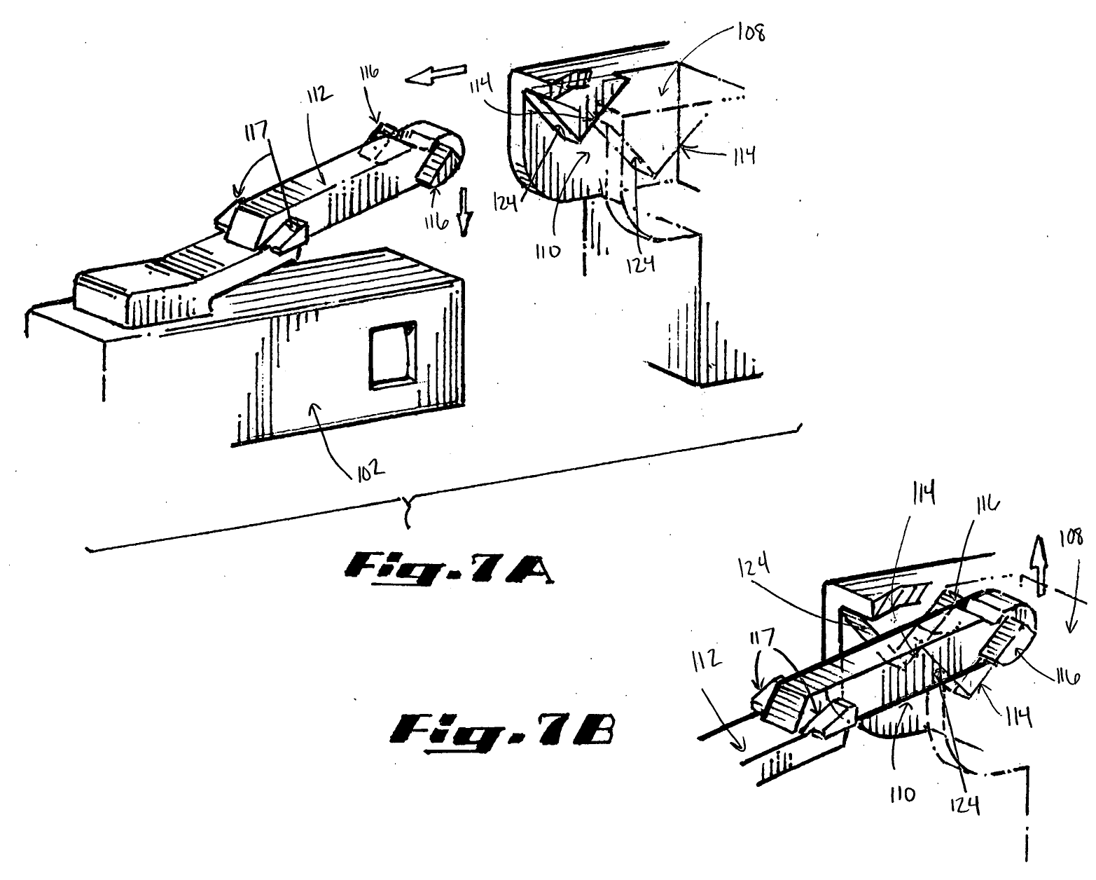

Referring to FIGS. 1-3, there is shown a preferred embodiment of a fiber optic connector in accordance with certain teachings of the present disclosure. Fiber optic connector 100 consists of a connector body 102 which is of material injection molded plastic or any other suitable material known in the art. The connector body 102 encloses the fiber optic ferrule, stem, and spring (not shown). The spring push 104 is affixed into the connector body 14 using mechanical latches 106 to remain attached during usage—this member holds the ferrule, stem and spring into the connector body 102.

Fiber optic connector 100 also consists of a latch pull 108 having a cavity 110 capable of at least partially enclosing latch 112. Latch pull 108 is of a material injection molded plastic or any other suitable material known in the art. Latch 112 is preferably a cantilever beam of the type and material typically found in the prior art, and is attached to connector body 102. Latch pull 108 is installed over the spring push 104 and the latch 112 in a manner so as to allow the latch pull 108 to freely slide over at least a portion of the connector body 10, including at least a portion of latch 112. Latch pull 108 has at least one, and preferably, a plurality of inclined planes 114 within cavity 110, which are designed to contact and slide against latch 112. Latch 112 may slide directly against inclined planes 114, or, as shown in FIGS. 1-3, latch 112 may contain two matched tabs 116 designed to contact and slide against inclined planes 114.

FIGS. 1-3 depict a preferred latch embodiment in accordance with certain teachings of the present disclosure. Cantilever beam latch 112 is biased in a downward direction such that inclined planes 114 force latch 112 into a position away from the connector body 102 when connector 100 is latched with a fiber optic receptacle (not shown). Latch 112 slides along inclined planes 114 when the latch pull is moved towards connector body 102, thereby moving latch 112 and locking tabs 117 against the locking surface of the fiber optic receptacle, thereby coupling connector 100 with the receptacle. When latch pull 108 is moved away from the fiber optic receptacle, latch 112 slides along inclined planes 114 and returns to a position closer to the connector body 102, thereby releasing connector 100 from the fiber optic receptacle.

As is evident from this description and from the drawings, latch pull 108 enables the operator to install and remove fiber optic connector 100 from a fiber optic receptacle without requiring room for the operator's fingers to directly release latch 112. Rather, the operator need only be able to pull the latch pull 108 away from the receptacle to release fiber optic connector 100. Additionally, it is a preferred embodiment that a strain relief boot 118 be permanently affixed to latch pull 108. This allows the strain relief boot 118 to transfer any pulling forces to latch pull 108 and thus subsequently release the fiber optic connector 100 from the fiber optic receptacle. The strain relief boot 118 provides even easier access and even easier removal of fiber optic connector 100 since the operator must only be able to reach strain relief boot 118 and pull it away from the receptacle to release fiber optic connector 100.

FIG. 1 also illustrates an alternative embodiment in which a duplex connector (the duplex portion shown as phantom 101) is provided in accordance with certain teachings of the present disclosure. Duplex connectors are well known in the art and may utilize the latch pull concept presented herein, although several latch pull designs are envisioned. One illustrative embodiment is shown in FIG. 1 in which the duplex connector 101 utilizes a single latch pull to detach the duplex latches.

FIGS. 4-7 depict the alternative embodiment of the latch and latch pull mechanism in which the cantilever beam latch 112 is biased in an upward direction. When latch pull 108 is moved away from the fiber optic receptacle as shown in FIG. 5, latch 112, and more specifically latch tabs 116, slides along inclined planes 114 and is forced into a position closer to the connector body 102, thereby providing the clearance for latch 112 and locking tabs 117 to clear the locking surface 122 of the fiber optic receptacle 120, thereby releasing connector 100 from fiber optic receptacle 120. FIGS. 4-6 depict one illustrative embodiment of inclined planes 114 where inclined planes 114 begin at the face of the latch pull. FIGS. 7A and 7B depict a second illustrative embodiment for this latch pull mechanism in which entrance planes 124 are used to help ensure proper latching of latch pull 108. As shown in FIG. 7A, latch 112 is forced downward as latch pull 108 is moved towards the connector body 102. As shown in FIG. 7B, latch 112 substantially returns to its biased position, which corresponds to the position in which latch 112 and locking tabs 117 are locked in fiber optic receptacle 120.

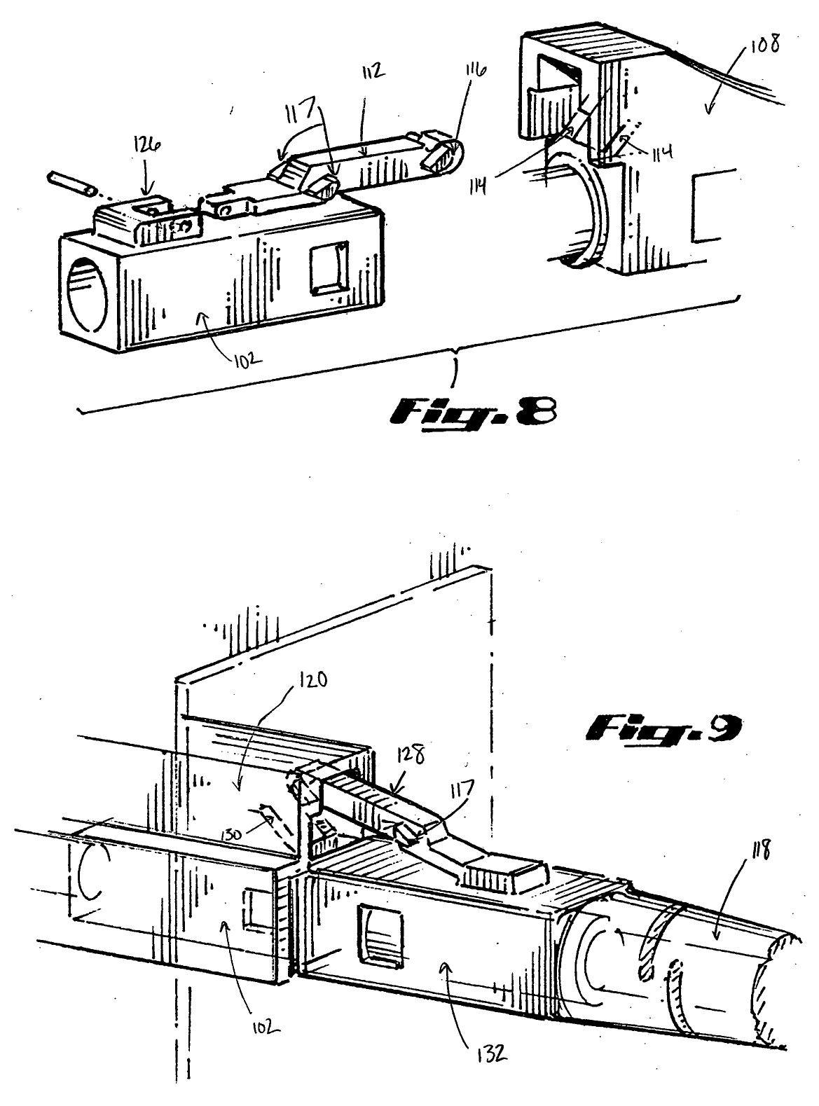

FIG. 8 shows an alternative latch embodiment in which latch 112 is attached to connector body 102 using a hinging mechanism 126. As in the preferred embodiment (cantilever beam latch biased down) previously described in relation to FIGS. 1 and 2, latch 112 slides along inclined planes 114 when the latch pull is moved towards connector body 102, thereby moving latch 112 and locking tabs 117 against the locking surface of the fiber optic receptacle, thereby coupling connector 100 with the receptacle. When latch pull 108 is moved away from the fiber optic receptacle, latch 112 slides along inclined planes 114 and returns to a position closer to the connector body 102, thereby releasing connector 100 from the fiber optic receptacle.

FIG. 9 shows yet another alternative embodiment of the present disclosure in which latch 128 is connected to latch pull 132. In this configuration, latch 128 is biased downward and extends in the direction of connector body 102 and fiber optic receptacle 120. Connector body 102 has at least one, and preferably, a plurality of inclined planes 130, which are designed to slide against latch 128. In this embodiment, inclined planes 130 force latch 128 away from latch pull 132 when latch pull 132 is moved towards connector body 102, thereby providing the necessary means for latch 128 and locking tabs 117 to couple with receptacle 120. Inclined planes 130 also allow latch 128 to return to its biased position closer to latch pull 132 when latch pull 132 is moved away from fiber optic receptacle 120, thereby decoupling latch 128 from fiber optic receptacle 120.

It is a preferred aspect of the present disclosure that all of the fiber optic connectors described herein are fully compatible with fiber optic receptacles designed for conventional connectors such as an “LC” connector. However, it is also envisioned that the apparatus and methods of the present disclosure may be utilized to improve upon the conventional connector designs to create an even smaller fiber optic connector for maximum density installations.

It will be apparent to one of skill in the art that described herein is a novel fiber optic connector and a novel method for achieving a high-density fiber optic installation using said connectors. A latch pull mechanism is provided such that movement of the latch pull relative to the connector body acts to decouple the latch mechanism, and thus the fiber optic connector, from a fiber optic receptacle. While the invention has been described with references to specific preferred embodiments, it is not limited to these embodiments. Although the embodiments described herein relate to fiber optic systems, one of skill in the art can appreciate that the disclosed subject matter can be utilized with any form of communication device or system. The invention may be modified or varied in many ways and such modifications and variations as would be obvious to one of skill in the art are within the scope and spirit of the invention and are included within the scope of the following claims.

What is claimed is:

1. A connector, comprising:
a connector body;
a latch attached to the connector body, the latch being capable of coupling with a receptacle; and
a latch pull movably engaged with the connector body;
wherein moving the latch pull relative to the connector body decouples the latch from the receptacle.

2. The connector of claim 1, wherein the latch pull has a cavity capable of at least partially enclosing the latch and at least one inclined plane that is slidable against the latch.

3. The connector of claim 1, wherein the latch pull is engaged with the connector body so as to allow the latch pull to slide over at least a portion of the connector body.

4. The connector of claim 1, wherein moving the latch pull relative to the connector body causes at least one inclined plane to slide against the latch, thus moving the latch to a position that decouples the latch from the receptacle.

5. The connector of claim 1, wherein the latch further comprises at least one tab attached to at least one side of the latch.

6. The connector of claim 5, wherein moving the latch pull away from the receptacle causes at least one inclined plane to slide against at least one tab, thus moving the latch to a position that decouples the latch from the receptacle.

7. The connector of claim 1, wherein the receptacle is designed to receive a conventional fiber optic connector.

8. The connector of claim 1, wherein the latch comprises a cantilever beam.

9. The connector of claim 1, wherein the latch is attached to the connector body with a hinging mechanism.

10. The connector of claim 1, further comprising a strain relief boot affixed to the latch pull.

11. The connector of claim 10, wherein moving the strain relief boot relative to the connector body forces the latch into a position that decouples the latch from the receptacle.

12. A connector, comprising:
a connector body;
a means for coupling the connector body with a receptacle by pushing the coupling means toward the receptacle; and
a means for decoupling the connector body from a receptacle by establishing relative movement between the decoupling means and the connector body.

13. A connector, comprising:
a connector body; and
a means for decoupling the connector body from a receptacle by pulling the decoupling means away from the receptacle.

14. A fiber optic connector, comprising:
a connector body;
a latch attached to the connector body, the latch being capable of coupling with a receptacle, the latch further comprising at least one tab attached to at least one side of the latch; and
a latch pull movably engaged with the connector body, the latch pull having a cavity capable of at least partially enclosing the latch and at least one inclined plane that is slidable against the latch;
wherein moving the latch pull away from the receptacle causes at least one inclined plane to slide against at least one tab, thus moving the latch to a position that decouples the latch from the receptacle.

15. The connector of claim 14, further comprising a strain relief boot affixed to the latch pull.

16. The connector of claim 15, wherein moving the strain relief boot away from the receptacle forces the latch into a position that decouples the latch from the receptacle.

17. A connector, comprising:
a connector body;
a latch pull movably engaged with the connector body; and
a latch attached to the latch pull, the latch capable of coupling with a receptacle;
wherein moving the latch pull toward the receptacle couples the latch with the receptacle; and
wherein moving the latch pull away from the receptacle decouples the latch from the receptacle.

18. The connector of claim 17, wherein the latch pull is engaged with the connector body so as to allow the latch pull to slide over at least a portion of the connector body.

19. The connector of claim 17, wherein the connector body contains at least one inclined plane capable of moving the latch into a position that couples the latch with the receptacle as the latch pull is moved toward the receptacle.

20. The connector of claim 17, wherein the latch further comprises at least one tab attached to at least one side of the latch.

21. The connector of claim 20, wherein moving the latch pull toward the receptacle causes at least one inclined plane to slide against at least one tab, thus moving the latch into a position that couples the latch with the receptacle.

22. The connector of claim 20, wherein moving the latch pull away from the receptacle causes at least one inclined plane to slide against at least one tab, thus moving the latch into a position that decouples the latch from the receptacle.

23. The connector of claim 17, wherein the latch comprises a cantilever beam.

24. The connector of claim 17, wherein the latch is attached to the latch pull with a hinge.

25. The connector of claim 17, further comprising a strain relief boot affixed to the latch pull.

26. A method for decoupling a connector from a receptacle, comprising:
providing a connector comprising a connector body, a latch attached to the connector body, and a latch pull having a cavity capable of at least partially enclosing the latch and at least one inclined plane that is slidable against the latch; and
moving the latch pull relative to the connector body so as to force the latch into a position that decouples the latch from the receptacle.

27. The method of claim 26, wherein the connector further comprises a strain relief 4 boot attached to the latch pull.

28. The method of claim 27, wherein moving the strain relief boot relative to the connector body forces the latch into a position that decouples the latch from the receptacle.
